(19) United States
(12) Patent Application Publication
(10) Pub. No.: US 2025/0300725 A1
(43) Pub. Date: Sep. 25, 2025

(54) BACKSCATTER DATA READING

(71) Applicant: QUALCOMM Incorporated, San Diego, CA (US)

(72) Inventors: Ahmed ELSHAFIE, San Diego, CA (US); Zhikun WU, Beijing (CN); Huilin XU, Temecula, CA (US); Yuchul KIM, San Diego, CA (US); Seyedkianoush HOSSEINI, San Diego, CA (US); Linhai HE, San Diego, CA (US)

(21) Appl. No.: 18/862,880

(22) PCT Filed: Jun. 30, 2022
(86) PCT No.: PCT/CN2022/102623

§ 371 Date: Nov. 4, 2024

(51) Int. Cl. H04B 7/22; H04B 5/77; H04B 5/79

(52) U.S. Cl. CPC H04B 7/22; H04B 5/77; H04B 5/79

(57) ABSTRACT

Certain aspects of the present disclosure provide techniques for wireless communication by a user equipment. The techniques include receiving, from a backscatter device, first backscatter data during one or more network entity downlink slots; receiving, from the backscatter device, during a network entity uplink slot immediately following the one or more network entity downlink slots, second backscatter data; and combining, at the user equipment, the first backscatter data and the second backscatter data to generate a backscatter data package.

### BACKGROUND

### Field of the Disclosure

Aspects of the present disclosure relate to wireless communications, and more particularly, to techniques for backscatter data reading.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment. The method includes receiving, from a backscatter device, first backscatter data during one or more network entity downlink slots; receiving, from the backscatter device, during a network entity uplink slot immediately following the one or more network entity downlink slots, second backscatter data; and combining, at the user equipment, the first backscatter data and the second backscatter data to generate a backscatter data package.

Another aspect provides a method of wireless communications by a backscatter user equipment. The method includes receiving, from a network entity, a first radio frequency (RF) source signal during one or more network entity downlink slots; sending, to a first user equipment, first backscatter data during at least a portion of the one or more network entity downlink slots; and sending, to the first user equipment, during a network uplink slot immediately following the one or more network entity downlink slots, second backscatter data.

Another aspect provides a method of wireless communications by a user equipment. The method includes receiving, from a backscatter device, first backscatter data during one or more network entity downlink slots and sending, to the backscatter device, during a network entity uplink slot immediately following the one or more network entity downlink slots, a RF source signal.

Another aspect provides a method of wireless communications by a network entity. The method includes sending, to a backscatter device, during one or more network entity downlink slots, a RF source signal and receiving, from the backscatter device, during a network entity uplink slot immediately following the one or more network entity downlink slots, first backscatter data.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example backscatter device.

FIGS. 6A and 6B depict aspects related to multiple RF source devices collaborating to allow a backscatter device to perform continuous backscatter communications.

FIGS. 7A and 7B depict aspects related to multiple RF source devices collaborating to allow a backscatter device to perform continuous backscatter communications.

FIGS. 8A and 8B depict aspects related to multiple RF source devices collaborating to allow a backscatter device to perform continuous backscatter communications.

FIGS. 9A and 9B depict aspects related to devices collaborating to allow a backscatter device to perform continuous backscatter communications.

FIG. 10 depicts a method for wireless communications.

FIG. 11 depicts a method for wireless communications.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for backscatter data reading.

A new generation of wireless devices eschews the conventional need of large on-board energy storage by harvesting energy from wireless signals (e.g., radio frequency (RF) signals) to perform wireless communications. Such energy harvesting devices may include, for example, radio-frequency identification (RFID) devices, internet of things (IoT) devices, and more generally, backscatter devices that are capable of receiving signals and “backscattering” them to another receiving device to perform wireless communications. Backscatter devices may be passive, in which case they include no on-board energy storage and rely entirely on harvested energy from received signals to perform wireless communications, or they may be semi-passive and include on-board energy storage to supplement their ability to harvest energy from received signals. In some aspects, in addition to harvesting power from RF sources, backscatter devices may accumulate energy from other direct energy sources, such as solar energy, in order to supplement power demands. Semi-passive backscatter devices may in some cases include power consuming RF components, such as analog to digital converters (ADCs), mixers, and oscillators.

Thus, backscatter devices are generally a type of user equipment that provides a low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, backscatter devices provide practical and necessary solutions to many networking applications that require, low-cost, small footprint, durable, maintenance-free, and long lifespan communications devices. For example, backscatter devices may be configured as long endurance industrial sensors, which mitigates the problems of replacing batteries in and around dangerous machinery.

To receive data from a backscatter device, an RF source device (e.g., a network entity, such a base station, a user equipment, or another purpose built RF source device) sends an RF signal (e.g., a continuous wave signal) to the backscatter device, which then uses the RF signal for energy harvesting and for modulating a signal reflection to a reader device. The reader device may be the RF source device in some cases, or another device, such as another user equipment, in other cases. The reader device can then detect the information sent by the backscatter device in the modulated signal reflection.

Because a backscatter device may be entirely dependent upon the RF signal to perform wireless communications, an issue arises when the RF source device cannot continuously provide the RF signal. For example, a time division duplexing system, such as a 5G wireless communications system, may use a time-delimited slot pattern in which some slots in the pattern cannot be used to send the downlink RF signal. Consider a four slot pattern comprising downlink-downlink-downlink-uplink (DDDU) slots. Because the final slot in the pattern is an uplink slot, the RF source device (e.g., a network entity, such as a base station), cannot provide the RF signal for more than the three consecutive downlink slots, and thus the reader device cannot receive backscattered data for more than the three consecutive slots in which the downlink RF signal is transmitted. Because reading data from a backscatter device may be relative slower, such transmission patterns may prevent successful reading of data and/or introduce extra latency into wireless communications, both of which are technical problems for a wireless communications system.

Aspects described herein overcome the aforementioned technical problems by configuring alternative RF source devices to collaborate with a primary RF source devices in order to provide an alternative RF source signal when the primary RF source device cannot. For example, a user equipment may provide an RF signal to a backscatter device when a primary RF source device (e.g., a network entity, such as a base station) is configured to discontinue its transmission of an RF signal, such as during a scheduled uplink slot.

Further, in some aspects a first reader device may receive a first portion of the backscattered data while a first RF source device is providing a first RF signal and a second reader device may receive a second portion of the backscattered data while a second RF source device is providing an second RF signal. The first portion and the second portion of the backscattered data may then be combined and decoded at either (or both) of the reader devices.

Accordingly, aspects described herein provide various methods for reading backscatter data that overcome technical limitations of current systems.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

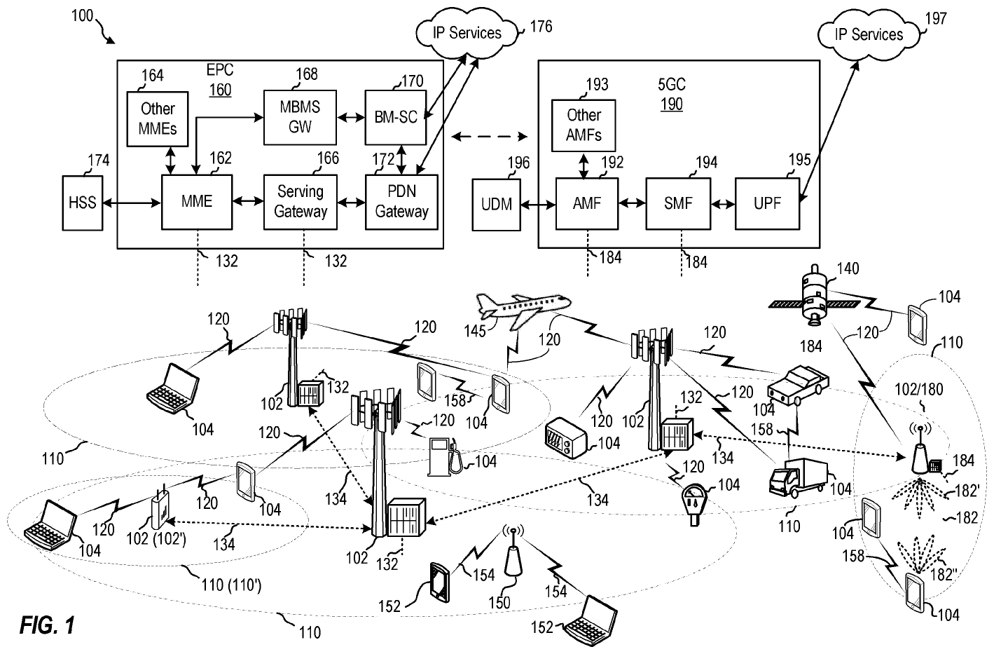

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

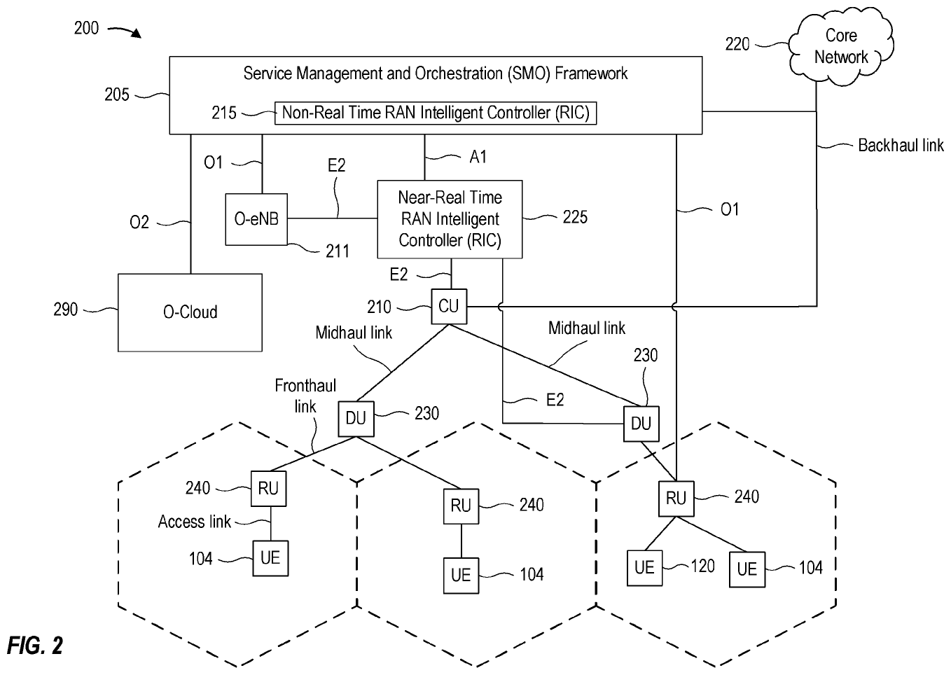

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168. a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

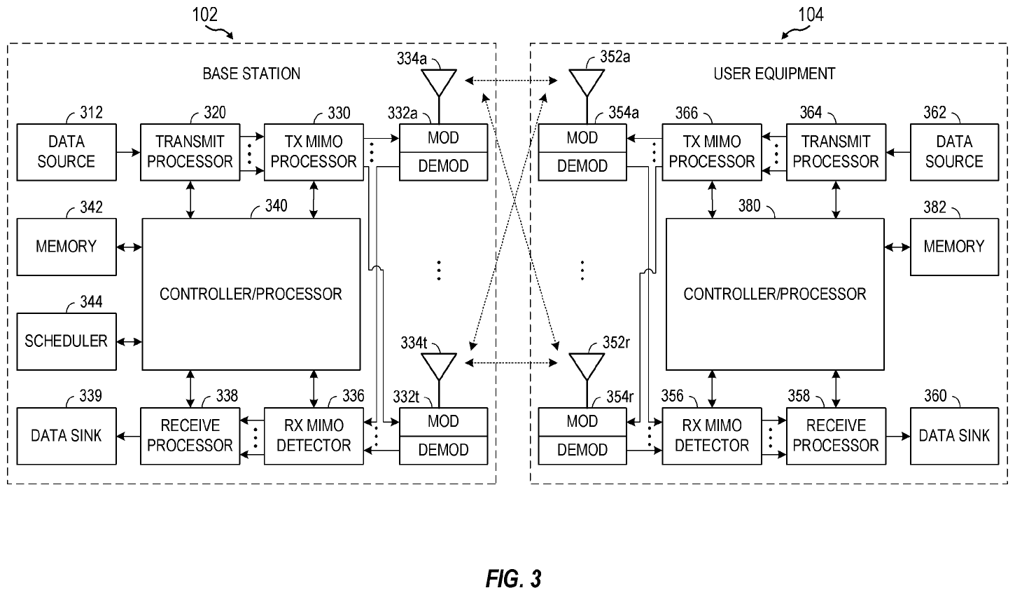

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

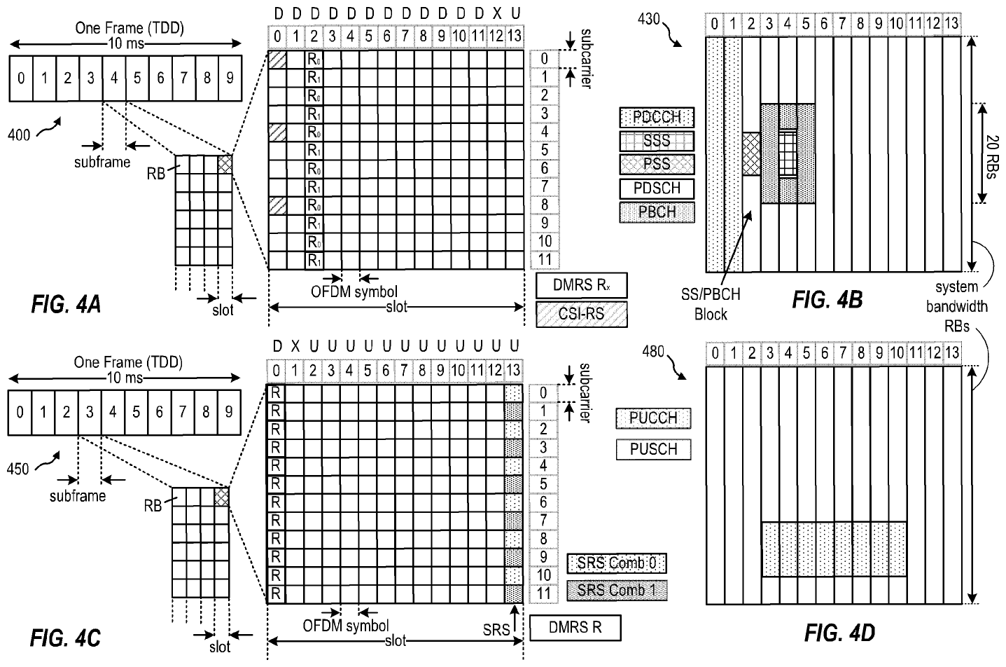

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD). in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0 25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Backscatter Device

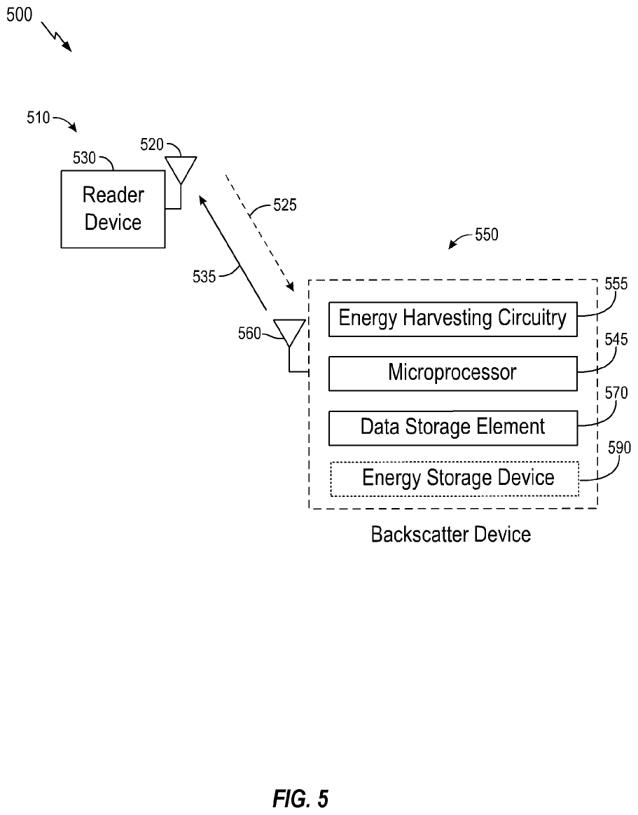

FIG. 5 depicts an example backscatter system 500 including reader device 510 and backscatter device 550. Reader device 510 may also be referred to as an RFID reader, interrogator, or a scanner. In some aspects, backscatter device 550 may be referred to as an RFID tag, RFID label, or an electronics label. In some aspects, reader device 510 may be integral with a user equipment, such as those described above.

In this example, reader device 510 includes an antenna 520 and an electronics unit 530. Antenna 520 radiates signals transmitted by reader device 510 and receives signals from backscatter device 550. Electronics unit 530 may thus include a transmitter and a receiver. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by reader device 510.

In this example, the backscatter device 550 includes an antenna 560, which receives signals from the reader device 510 and radiates signals transmitted by backscatter device 550.

Backscatter device 550 further includes data storage element 570, which stores information for backscatter device 550, for example, in an electrically erasable programmable read-only memory (EEPROM) or another type of memory.

Backscatter device 550 may also include an electronics unit that can process received signals and generate signals to be transmitted, such as backscattered signals.

In some aspects, backscatter device 550 may be a passive backscatter device having no energy storage device (e.g., no battery). In such cases, induction may be used to power the backscatter device 550. For example, in some cases, a magnetic field from a signal transmitted by reader device 510 may induce an electrical current in backscatter device 550, which may then operate based on the induced current. Backscatter device 550 can then radiate its signal in response to receiving a signal from the reader device 510 or some other device. In other cases, the backscatter device 550 may optionally include energy storage device 590, such as a battery, capacitor, super-capacitor, etc., for storing energy harvested using energy harvesting circuitry 555.

In one example, backscatter device 550 may be read by placing the reader device 510 within close proximity to the backscatter device 550 (or vice versa). Reader device 510 may radiate a first signal 525 via the antenna 520. In some cases, first signal 525 may be known as an interrogation signal or an energy signal. Energy of the first signal 525 may be coupled from the reader device antenna 520 to backscatter device antenna 560 via magnetic coupling in one example. In other words, backscatter device 550 may receive the first signal 525 from reader device 510 via antenna 560 and energy of the first signal 525 may be harvested using energy harvesting circuitry 555 (e.g., an RF transducer) and used to power the backscatter device 550. For example, energy of the first signal 525 received by the backscatter device 550 may be used to power microprocessor 545, which may, in turn, retrieve information stored in data storage element 570 and transmit the retrieved information via second signal 535 using antenna 560.

In some cases, microprocessor 545 may generate second signal 535 by modulating a baseband signal (e.g., generated using energy of the first signal 525) with the information retrieved from data storage element 570. In some cases, this second signal 535 may be known as a backscatter modulated information signal or a backscatter signal. Thereafter, second signal 535 is transmitted to reader device 510 via antenna 560. Reader device 510 receives second signal 535 from backscatter device 550 via antenna 520 and may process (e.g., demodulate) the received signal to obtain the sent in the second signal 535.

In some aspects, RFID system 500 may be designed to operate at 13.56 MHz or some other frequency (e.g., an ultra-high frequency (UHF) band at 900 MHz). Further, reader device 510 may have a specified maximum transmit power level, e.g., imposed by a regulator body, which may limit the distance at which backscatter device 550 can be read by reader device 510.

### Aspects Related to Backscatter Data Reading

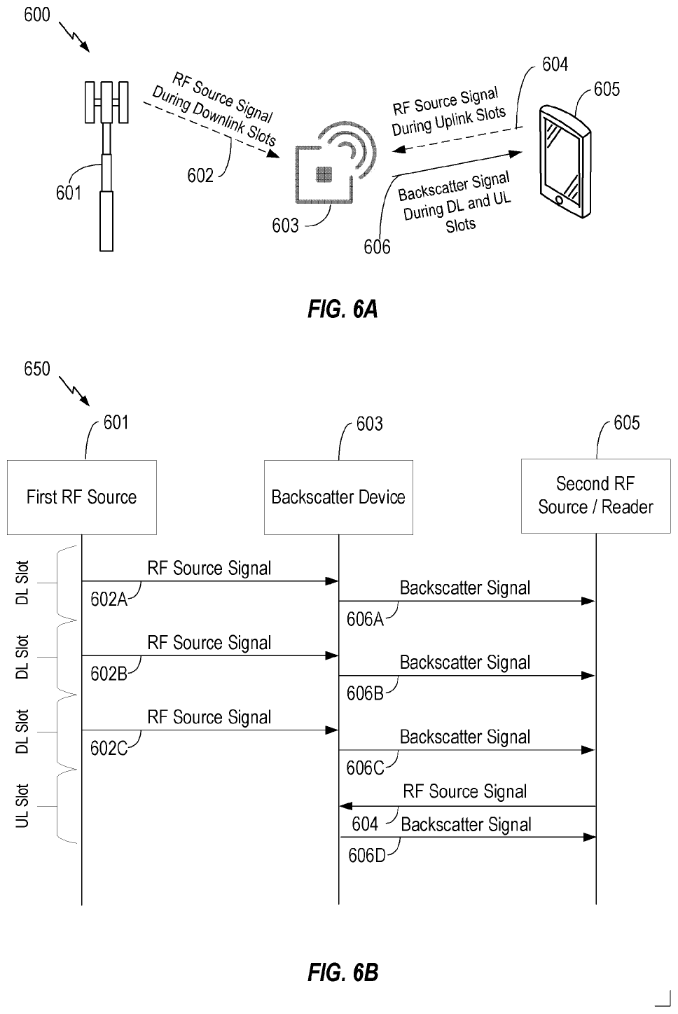

FIG. 6A depicts an example 600 of multiple RF source devices collaborating to allow a backscatter device to perform continuous backscatter communications.

In example 600, a first RF source device 601 (e.g., a network entity, such as a base station (depicted), or a user equipment) transmits an RF source signal 602 to backscatter device 603 during its scheduled downlink slots and a second RF source (and reader) device 605 (e.g., a user equipment or another dedicated RF device) transmits a second RF source signal 604 to backscatter device 603 during first RF source device 601's scheduled uplink slots. In this way, backscatter device 603 is able to continuously receive an RF source signal, modulate it, and reflect it (transmit it) as backscatter signal 606. Beneficially, this allows for backscatter device 603 to transmit backscatter signal 606 for a longer duration of time, including while first RF source device 601 cannot due to its uplink slot schedule, which improves latency of the backscatter communications to second RF source (and reader) device 605. In some cases, RF source signals 602 and 604 may be continuous wave signals.

In this example, second RF source (and reader) device 605 is capable of full duplex in-band operation, such that it can transmit RF source signal 604 and receive backscatter signal 606 concurrently (e.g., during the same slot).

In some aspects, second RF source device 605 may receive from first RF source device 601 a configured uplink grant in which to transmit RF source signal 604. The uplink grant may be timed to coincide with first RF source device 601's own uplink schedule (e.g., when first RF source device 601 cannot transmit a downlink RF source signal to backscatter device 603). Further, in some aspects, second RF source device 605 may receive from first RF source device 601 a semi-persistent scheduling configuration and thereafter receive, from first RF source device 601, the configured uplink grant during a physical downlink control channel (PDCCH) occasion scheduled based on the semi-persistent scheduling configuration.

In some aspects, first RF source device 601 may be referred to as a primary RF source device and second RF source device 605 may be referred to as a secondary RF source device. In some aspects, a primary RF source device is one that transmits an RF source signal during the majority of the slots in any given slot patterns. So, in example 650, because first RF source device 601 transmits the RF source signal in three of four slots in the slot pattern, it is considered the primary RF source device.

FIG. 6B depicts an example data flow 650 corresponding to FIG. 6A.

As depicted, first RF source device 601 transmits RF source signal 602A during a first scheduled downlink (DL) slot for first RF source device 601. During this same downlink slot, backscatter device 603 receives the RF source signal 602A and backscatters it via backscatter signal 606A to second RF source (and reader) device 605, which receives the data encoded into backscatter signal 606A by backscatter device 603.

As depicted, first RF source device 601 continues to transmit RF source signals 602B-C during second and third scheduled downlink slots for first RF source device 601. During these downlink slots, backscatter device 603 receives the RF source signals 602B-C and backscatters them via backscatter signals 606B-C to second RF source (and reader) device 605, which receives the data encoded into backscatter signals 606B-C by backscatter device 603.

Finally, during a scheduled uplink (UL) slot for first RF source device 601, second RF source (and reader) device 605 transmits RF source signal 604 to backscatter device 603 and receives, from backscatter device 603, backscatter signal 606D, which second RF source (and reader) device 605 then decodes to receive the data encoded in backscatter signal 606D.

Note that while RF source signals 602A-C are depicted separately to illustrate the slot-specific timing, these signals may be continuously transmitted without interruption during the scheduled downlink slots of first RF source device 601. Further, the specific slot pattern depicted in example 650 (e.g., downlink-downlink-downlink-uplink or DDDU) is just one example, and many other are possible that include different patterns and different numbers of slots within the pattern.

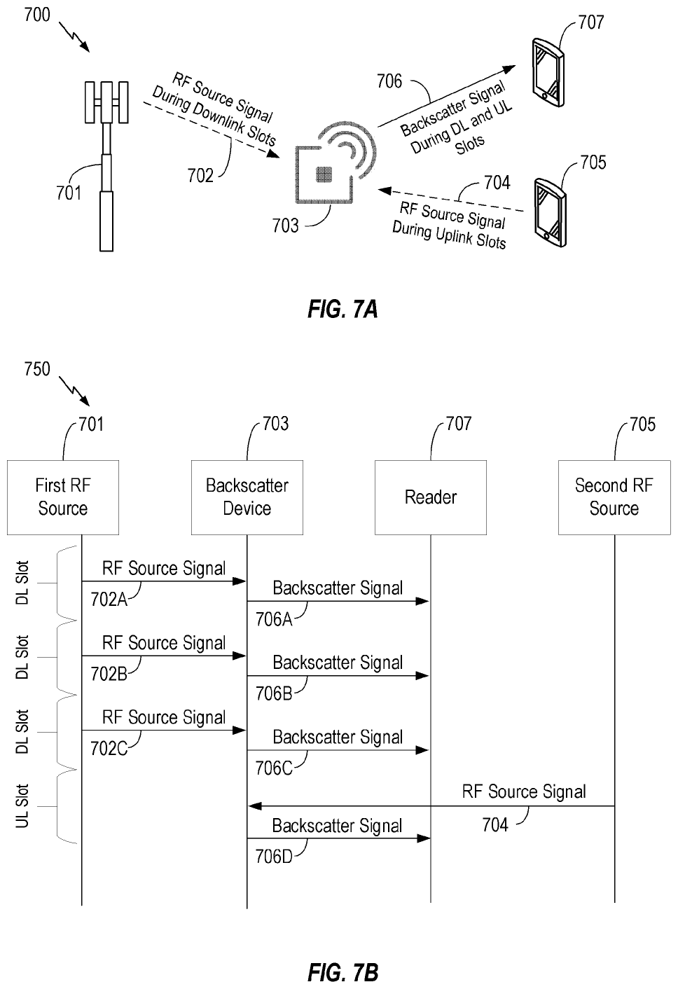

FIG. 7A depicts another example 700 of multiple RF source devices collaborating to allow a backscatter device to perform continuous backscatter communications.

In example 700, a first RF source device 701 (e.g., a network entity, such as a base station (depicted), or a user equipment) transmits an RF source signal 702 to backscatter device 703 during its scheduled downlink slots and a second RF source device 705 (e.g., a user equipment, another network entity, or another dedicated RF device) transmits a second RF source signal 704 to backscatter device 703 during first RF source device 701's scheduled uplink slots. In this way, backscatter device 703 is able to continuously receive an RF source signal, modulate it, and reflect it (transmit it) as backscatter signal 706. Beneficially, this allows for backscatter device 703 to transmit backscatter signal 706 for a longer duration of time, including while first RF source device 701 cannot due to its uplink slot schedule, which improves latency of the backscatter communications to reader device 707 in this example. In some cases, RF source signals 702 and 704 may be continuous wave signals.

In this example, reader device 707 is capable of half duplex operation, such that cannot transmit an RF source signal while receiving backscatter signal 706, as in the example of FIG. 6A. Accordingly, second RF source device 705 is used as a “helper” device to provide RF source signal 704 during first RF source device 701's scheduled uplink slot.

As in the example above, second RF source device 705 may receive from first RF source device 701 a configured uplink grant in which to transmit RF source signal 704. The uplink grant may be timed to coincide with first RF source device 701's own uplink schedule (e.g., when first RF source device 701 cannot transmit a downlink RF source signal to backscatter device 703). Further, in some aspects, second RF source device 705 may receive from first RF source device 701 a semi-persistent scheduling configuration and thereafter receive, from first RF source device 701, the configured uplink grant during a physical downlink control channel (PDCCH) occasion scheduled based on the semi-persistent scheduling configuration.

In some aspects, backscatter device 703 may include an energy storage device (e.g., a battery, capacitor, super-capacitor, or the like, such as energy storage device 590 in FIG. 5). Thus, in some aspects, backscatter device 703 may use its energy storage device to further assist with generating backscatter signal 706 when second RF source device 705 is providing RF source signal 704. In this way, backscatter device 703 may compensate for part or all of backscatter device 703's integrated circuitry's (e.g., microprocessor 545 in FIG. 5) required power/energy only while a helping device (e.g., second RF source device 705) is still needed. When backscatter device 703 utilizes its energy storage in this manner, second RF source device 705 may be able to beneficially transmit RF source signal 704 at a lower power level and thus create less interference to nearby devices while also using less energy. Notably, this approach works even if backscatter device 703 does not include any active RF components capable of generating (rather than modulating) a waveform for transmission.

In some aspects, whether or not backscatter device 703 has an energy storage device and the capability to assist in the manner just described, may be indicated to, for example, first RF source device 701, which may be a network entity. This indication may allow first RF source device 701, or another network entity, to configure second RF source device 705 to transmit a reduced power second RF source signal 704.

FIG. 7B depicts an example data flow 750 corresponding to FIG. 7A.

As depicted, first RF source device 701 transmits RF source signal 702A during a first scheduled downlink (DL) slot for first RF source device 701. During this same downlink slot, backscatter device 703 receives the RF source signal 702A and backscatters it via backscatter signal 706A to reader device 707, which receives the data encoded into backscatter signal 706A by backscatter device 703.

As depicted, first RF source device 701 continues to transmit RF source signals 702B-C during second and third scheduled downlink slots for first RF source device 701. During these downlink slots, backscatter device 703 receives the RF source signals 702B-C and backscatters them via backscatter signals 706B-C to reader device 707, which receives the data encoded into backscatter signals 706B-C by backscatter device 703.

Finally, during a scheduled uplink (UL) slot for first RF source device 701, second RF source device 705 transmits RF source signal 704 to backscatter device 703, which then backscatters the signal with encoded data in backscatter signal 706D. As above, in some cases, backscatter device 703 may assist in generating backscatter signal 706D with its own energy store. Reader device 707 then receives backscatter signal 706D and may thereafter process the received data.

Note that, as above, while RF source signals 702A-C are depicted separately to illustrate the slot-specific timing, these signals may be continuously transmitted without interruption during the scheduled downlink slots of first RF source device 701. Further, the specific slot pattern depicted in example 750 (e.g., downlink-downlink-downlink-uplink or DDDU) is just one example, and many other are possible that include different patterns and different numbers of slots within the pattern.

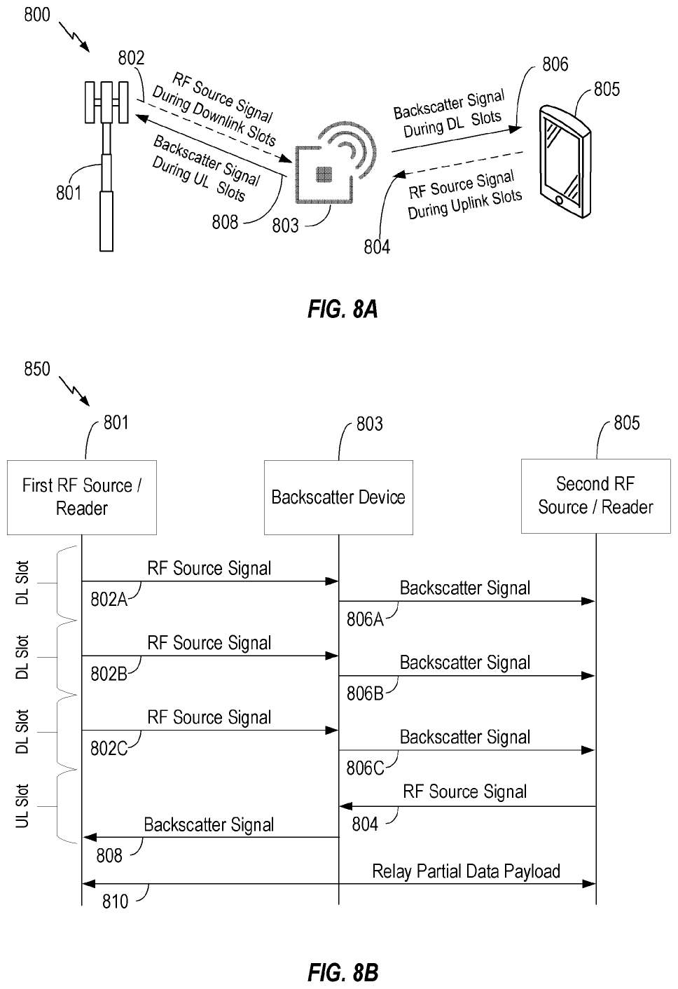

FIG. 8A depicts another example 800 of multiple RF source devices collaborating to allow a backscatter device to perform continuous backscatter communications.

In example 800, a first RF source (and reader) device 801 (e.g., a network entity, such as a base station (depicted), or a user equipment) transmits an RF source signal 802 to backscatter device 803 during its scheduled downlink slots and a second RF source (and reader) device 805 (e.g., a user equipment) transmits a second RF source signal 804 to backscatter device 803 during first RF source device 801's scheduled uplink slots. In this way, backscatter device 803 is able to continuously receive an RF source signal, modulate it, and reflect it (transmit it) as backscatter signals 806 and 808. In some cases, RF source signals 802 and 804 may be continuous wave signals.

In this example, second RF source (and reader) device 805 is capable of half-duplex operation, such that it can either transmit RF source signal 804 or receive backscatter signal 806, but it cannot do both concurrently (e.g., during the same slot). Unlike the example of FIG. 7A, in example 800 there is no helper device to provide an RF source signal during first RF source (and reader) device 801's scheduled uplink slot. Accordingly, first RF source (and reader) device 801 and second RF source (and reader) device 805 switch roles during first RF source (and reader) device 801's scheduled uplink slot, such that second RF source (and reader) device 805 transmits the RF source signal 804 and first RF source (and reader) device 801 receives backscatter signal 808 from backscatter device 803. Thus, both first RF source (and reader) device 801 and second RF source (and reader) device 805 act as both RF source signal transmitters and readers of backscattered signals from backscatter device 803.

A consequence of example 800 is that both first RF source (and reader) device 801 and second RF source (and reader) device 805 may only receive partial data payloads. Accordingly, after receiving their partial data payloads, one of first RF source (and reader) device 801 or second RF source (and reader) device 805 may send its partial data payload to the other device so that it may be combined and processed (e.g., decoded). Thus, in this example, each of first RF source (and reader) device 801 and second RF source (and reader) device 805 act as readers and one of first RF source (and reader) device 801 and second RF source (and reader) device 805 acts as a relay for data received from backscatter device 803.

In some aspects, second RF source device 805 may receive from first RF source device 801 a configured uplink grant in which to transmit RF source signal 804. The uplink grant may be timed to coincide with first RF source device 801's own uplink schedule (e.g., when first RF source device 801 cannot transmit a downlink RF source signal to backscatter device 803). Further, in some aspects, second RF source device 805 may receive from first RF source device 801 a semi-persistent scheduling configuration and thereafter receive, from RF source device 801, the configured uplink grant during a physical downlink control channel (PDCCH) occasion scheduled based on the semi-persistent scheduling configuration.

Note that while example 800 depicts two RF source and reader devices, 801 and 805, in other examples, any number of RF source and reader devices may collaborate and may forward partial data payloads to a primary reader device for processing. In some aspects, the primary reader device may be one of the RF source and reader devices, while in other aspects, the primary reader device may be a separate device that does not act as an RF source device.

FIG. 8B depicts an example data flow 850 corresponding to FIG. 8A.

As depicted, first RF source (and reader) device 801 transmits RF source signal 802A during a first scheduled downlink (DL) slot for first RF source device 801. During this same downlink slot, backscatter device 803 receives the RF source signal 802A and backscatters it via backscatter signal 808A to second RF source (and reader) device 805, which receives the data encoded into backscatter signal 806A by backscatter device 803.

First RF source (and reader) device 801 then continues to transmit RF source signals 802B-C during second and third scheduled downlink slots for first RF source (and reader) device 801. During these downlink slots, backscatter device 803 receives the RF source signals 802B-C and backscatters them via backscatter signals 806B-C to second RF source (and reader) device 805, which receives the data encoded into backscatter signals 806B-C by backscatter device 803.

Then, during a scheduled uplink (UL) slot for first RF source (and reader) device 801, second RF source (and reader) device 805 transmits RF source signal 804 to backscatter device 803, which backscatters the signal as backscatter signal 808 to RF source (and reader) device 801, which receives the data encoded into backscatter signal 808 by backscatter device 803.

Finally, one of first RF source (and reader) device 801 or second RF source (and reader) device 805 relays its partial data payload to the other device. In FIG. 8B, arrow 810 is depicted as bidirectional to indicate that either device can relay the partial data payload to the other device based on whichever device is the intended recipient device. In some aspects, the target device for the full data payload may be indicated by appropriate messaging to and/or between first RF source (and reader) device 801 and second RF source (and reader) device 805.

In some aspects, the relaying type could be one of (1) amplify and forward type relaying; (2) delay and forward type relaying (e.g., if the pieces/parts/data chunks collected by a device is decodable); (3) compress and forward type relaying (e.g., of quantized observations that are not decided); or (4) relaying of log likelihood ratios (e.g., related to the likelihood of a codeword received in a signal) if log likelihood ratios are used for decoding. In the case of compress and forward type relaying, quantization or compression level can be different and based on receiving device (device that will relay) capability and can be per configuration. In some aspects, first RF source (and reader) device 801 may relay to second RF source (and reader) device 805, or vice versa, I/Q data from the backscatter signal 804 and 808.

Note that while RF source signals 802A-C are depicted separately to illustrate the slot-specific timing, these signals may be continuously transmitted without interruption during the scheduled downlink slots of first RF source device 801. Further, the specific slot pattern depicted in example 850 (e.g., downlink-downlink-downlink-uplink or DDDU) is just one example, and many other are possible that include different patterns and different numbers of slots within the pattern.

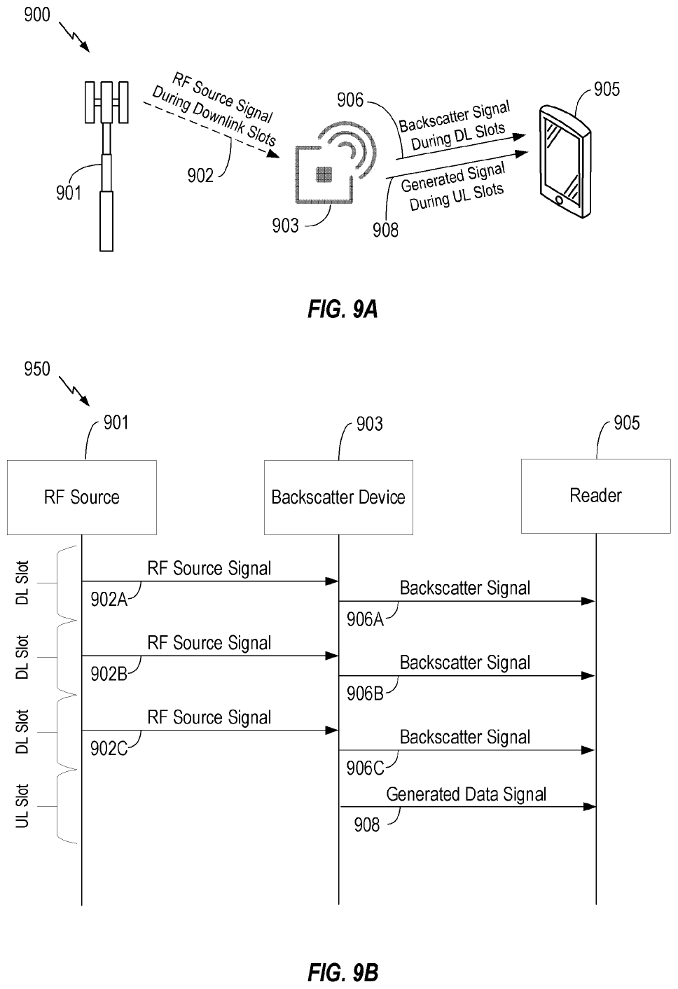

FIG. 9A depicts another example 900 of multiple RF source devices collaborating to allow a backscatter device to perform continuous backscatter communications.

In example 900, a RF source device 901 (e.g., a network entity, such as a base station (depicted), or a user equipment) transmits an RF source signal 902 to backscatter device 903 during its scheduled downlink slots. However, in this example, reader device 905 is a half-duplex device that cannot provide a source RF signal while receiving backscatter signal 906, and there are no other helper devices available as in the example of FIG. 7A. Instead, in this example, backscatter device 903 includes on-board energy storage (e.g., a battery, capacitor, super-capacitor, or the like, such as energy storage device 590 in FIG. 5) and active RF components capable of generating a data signal 908 for transmission to reader device 905 when a source RF signal is not available for backscattering. In this way, backscatter device 903 is able to continuously transmit data-bearing signals (906 and 908) to reader device 905 during RF source 901's downlink and uplink slots, both with and without a source RF signal.

FIG. 9B depicts an example data flow 950 corresponding to FIG. 9A.

As depicted, RF source device 901 transmits RF source signal 902A during a first scheduled downlink (DL) slot for RF source device 901. During this same downlink slot, backscatter device 903 receives the RF source signal 902A and backscatters it via backscatter signal 906A to reader device 905, which receives the data encoded into backscatter signal 906A by backscatter device 903.

As depicted, RF source device 901 continues to transmit RF source signals 902B-C during second and third scheduled downlink slots for RF source device 901. During these downlink slots, backscatter device 903 receives the RF source signals 902B-C and backscatters them via backscatter signals 906B-C to reader device 905, which receives the data encoded into backscatter signals 906B-C by backscatter device 903.

Finally, during a scheduled uplink (UL) slot for RF source device 901, backscatter device 903 uses its own internal energy store to generate and transmit data signal 908 to reader device 905. In this example, backscatter device 903 includes active RF components for generating a waveform for data signal 908 (rather than modulating a source signal for backscattering).

In some aspects, whether or not backscatter device 903 has an energy storage device and active RF components configured for generating data signal 908, may be indicated to, for example, RF source device 901, which may be a network entity.

Note that while RF source signals 902A-C are depicted separately to illustrate the slot-specific timing, these signals may be continuously transmitted without interruption during the scheduled downlink slots of RF source device 901. Further, the specific slot pattern depicted in example 950 (e.g., downlink-downlink-downlink-uplink or DDDU) is just one example, and many other are possible that include different patterns and different numbers of slots within the pattern.

### Example Operations of a User Equipment

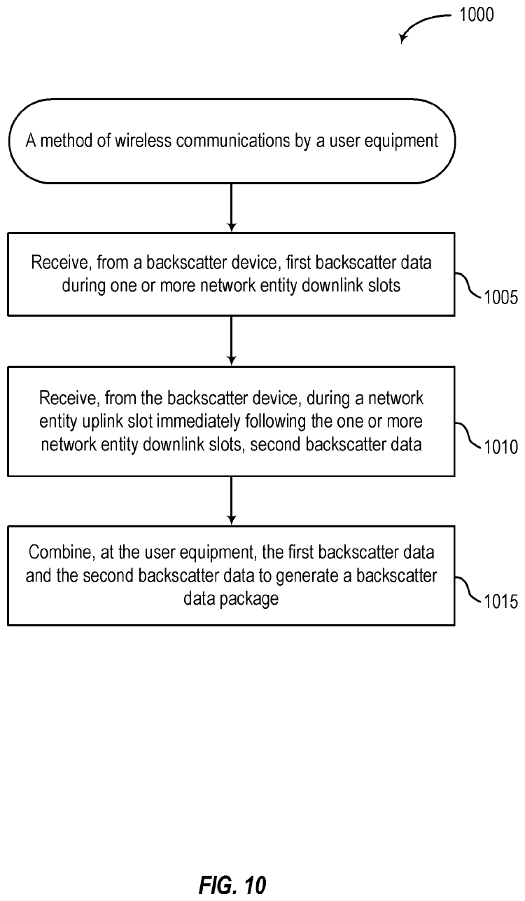

FIG. 10 shows an example of a method 1000 for wireless communications by a user equipment, such as UE 104 of FIGS. 1 and 3.

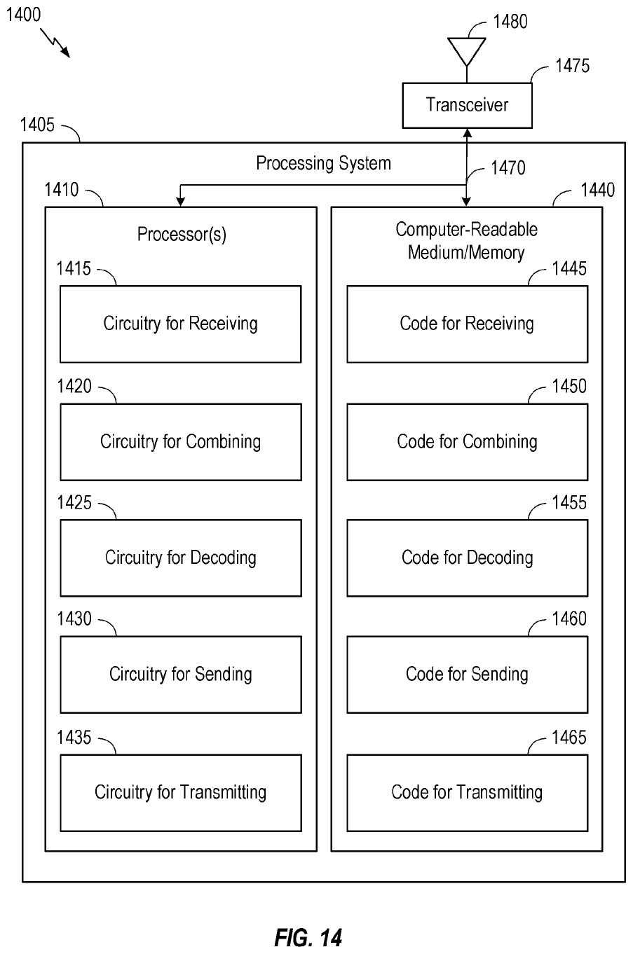

Method 1000 begins at step 1005 with receiving, from a backscatter device, first backscatter data during one or more network entity downlink slots. In some cases, the operations of this step refer to, or may be performed by, circuitry for receiving and/or code for receiving as described with reference to FIG. 14.

Method 1000 then proceeds to step 1010 with receiving, from the backscatter device, during a network entity uplink slot immediately following the one or more network entity downlink slots, second backscatter data. In some cases, the operations of this step refer to, or may be performed by, circuitry for receiving and/or code for receiving as described with reference to FIG. 14.

Method 1000 then proceeds to step 1015 with combining, at the user equipment, the first backscatter data and the second backscatter data to generate a backscatter data package. In some cases, the operations of this step refer to, or may be performed by, circuitry for combining and/or code for combining as described with reference to FIG. 14.

In some aspects, the method 1000 further includes decoding the backscatter data package. In some cases, the operations of this step refer to, or may be performed by, circuitry for decoding and/or code for decoding as described with reference to FIG. 14.

In some aspects, the method 1000 further includes sending, to a reading device, the backscatter data package. In some cases, the operations of this step refer to, or may be performed by, circuitry for sending and/or code for sending as described with reference to FIG. 14.

In some aspects, the backscatter data package comprises I/Q data.

In some aspects, the backscatter data package comprises log likelihood ratio data.

In some aspects, sending, to the reading device, the backscatter data package comprises one of: amplifying and forwarding the backscatter data package; delaying and forwarding the backscatter data package; or compressing and forwarding the backscatter data package.

In some aspects, the reading device is a network entity.

In some aspects, the reading device is another user equipment.

In some aspects, the method 1000 further includes transmitting, to the backscatter device, a RF source signal during the network entity uplink slot. In some cases, the operations of this step refer to, or may be performed by, circuitry for transmitting and/or code for transmitting as described with reference to FIG. 14.

In some aspects, the user equipment is configured in a full-duplex in-band operating mode in order to transmit the RF source signal and receive the second backscatter data during the network entity uplink slot.

In some aspects, the method 1000 further includes receiving, from a network entity, a configured uplink grant, wherein transmitting the RF source signal during the network entity uplink slot is performed in accordance with the configured uplink grant. In some cases, the operations of this step refer to, or may be performed by, circuitry for receiving and/or code for receiving as described with reference to FIG. 14.

In some aspects, the method 1000 further includes receiving, from the network entity, a semi-persistent scheduling configuration. In some cases, the operations of this step refer to, or may be performed by, circuitry for receiving and/or code for receiving as described with reference to FIG. 14.

In some aspects, the method 1000 further includes receiving, from the network entity, the configured uplink grant during a PDCCH occasion scheduled based on the semi-persistent scheduling configuration. In some cases, the operations of this step refer to, or may be performed by, circuitry for receiving and/or code for receiving as described with reference to FIG. 14.

In some aspects, the backscatter device comprises a RFID tag.

In some aspects, the backscatter device comprises a second user equipment comprising a RFID tag radio.

In one aspect, method 1000, or any aspect related to it, may be performed by an apparatus, such as communications device 1400 of FIG. 14, which includes various components operable, configured, or adapted to perform the method 1000. Communications device 1400 is described below in further detail.

Note that FIG. 10 is just one example of a method, and other methods including fewer, additional, or alternative steps are possible consistent with this disclosure.

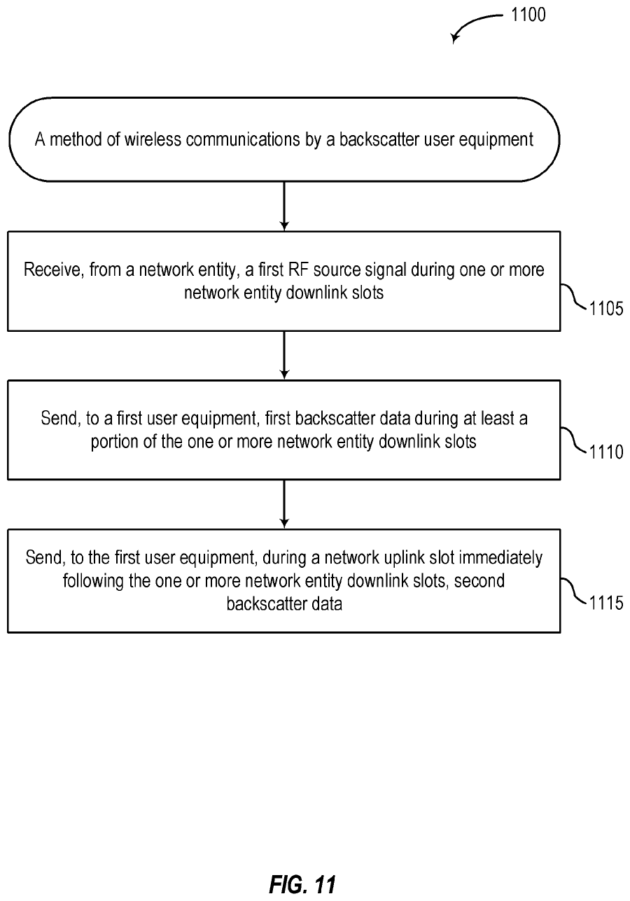

FIG. 11 shows an example of a method 1100 for wireless communications by a backscatter user equipment, such as UE 104 of FIGS. 1 and 3 or backscatter device 550 of FIG. 5.

Method 1100 begins at step 1105 with receiving, from a network entity, a first RF source signal during one or more network entity downlink slots. In some cases, the operations of this step refer to, or may be performed by, circuitry for receiving and/or code for receiving as described with reference to FIG. 14.

Method 1100 then proceeds to step 1110 with sending, to a first user equipment, first backscatter data during at least a portion of the one or more network entity downlink slots. In some cases, the operations of this step refer to, or may be performed by, circuitry for sending and/or code for sending as described with reference to FIG. 14.

Method 1100 then proceeds to step 1115 with sending, to the first user equipment, during a network uplink slot immediately following the one or more network entity downlink slots, second backscatter data. In some cases, the operations of this step refer to, or may be performed by, circuitry for sending and/or code for sending as described with reference to FIG. 14.

In some aspects, the method 1100 further includes receiving a second RF source signal during the network uplink slot. In some cases, the operations of this step refer to, or may be performed by, circuitry for receiving and/or code for receiving as described with reference to FIG. 14.

In some aspects, the second RF source signal is received from the first user equipment.

In some aspects, the second RF source signal is received from a second user equipment.

In some aspects, sending, to the first user equipment, during the network uplink slot, the second backscatter data comprises sending the second backscatter data using energy from an energy storage device within the backscatter user equipment.

In some aspects, sending, to the first user equipment, during the network uplink slot, the second backscatter data comprises sending the second backscatter data using energy from an energy storage device within the backscatter user equipment and energy harvested from the second RF source signal.

In some aspects, the backscatter user equipment comprises a RFID tag.

In some aspects, the backscatter user equipment comprises a RFID tag radio.

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

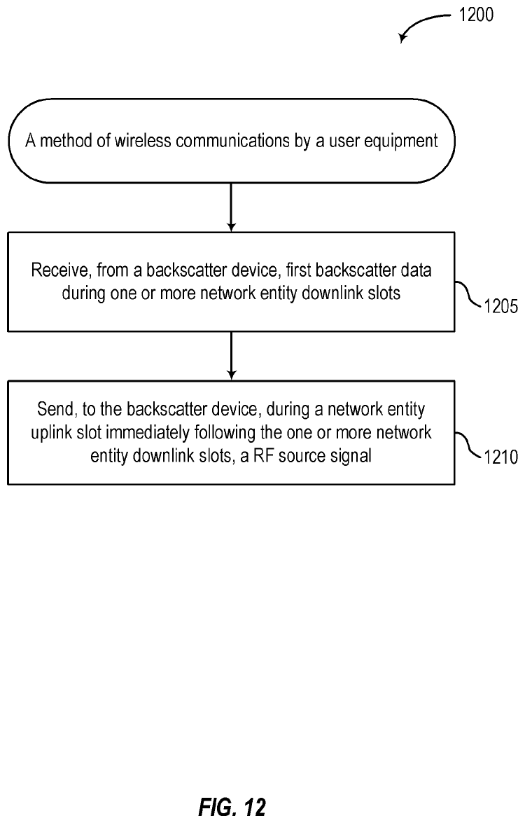

FIG. 12 shows an example of a method 1200 for wireless communications by a user equipment, such as UE 104 of FIGS. 1 and 3.

Method 1200 begins at step 1205 with receiving, from a backscatter device, first backscatter data during one or more network entity downlink slots. In some cases, the operations of this step refer to, or may be performed by, circuitry for receiving and/or code for receiving as described with reference to FIG. 14.

Method 1200 then proceeds to step 1210 with sending, to the backscatter device, during a network entity uplink slot immediately following the one or more network entity downlink slots, a RF source signal. In some cases, the operations of this step refer to, or may be performed by, circuitry for sending and/or code for sending as described with reference to FIG. 14.

In some aspects, the method 1200 further includes receiving, from a network entity, second backscatter data. In some cases, the operations of this step refer to, or may be performed by, circuitry for receiving and/or code for receiving as described with reference to FIG. 14.

In some aspects, the method 1200 further includes combining, at the user equipment, the first backscatter data and the second backscatter data to generate a backscatter data package. In some cases, the operations of this step refer to, or may be performed by, circuitry for combining and/or code for combining as described with reference to FIG. 14.

In some aspects, the method 1200 further includes decoding the backscatter data package. In some cases, the operations of this step refer to, or may be performed by, circuitry for decoding and/or code for decoding as described with reference to FIG. 14.

In some aspects, the method 1200 further includes receiving, from the network entity, an indication that the second backscatter data will be relayed to the user equipment. In some cases, the operations of this step refer to, or may be performed by, circuitry for receiving and/or code for receiving as described with reference to FIG. 14.

In some aspects, the method 1200 further includes sending, to a network entity, the first backscatter data. In some cases, the operations of this step refer to, or may be performed by, circuitry for sending and/or code for sending as described with reference to FIG. 14.

In some aspects, the method 1200 further includes receiving, from the network entity, and indication to relay the first backscatter data to the network entity. In some cases, the operations of this step refer to, or may be performed by, circuitry for receiving and/or code for receiving as described with reference to FIG. 14.

In some aspects, the backscatter device comprises a RFID tag.

In some aspects, the backscatter device comprises a second user equipment comprising a RFID tag radio.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

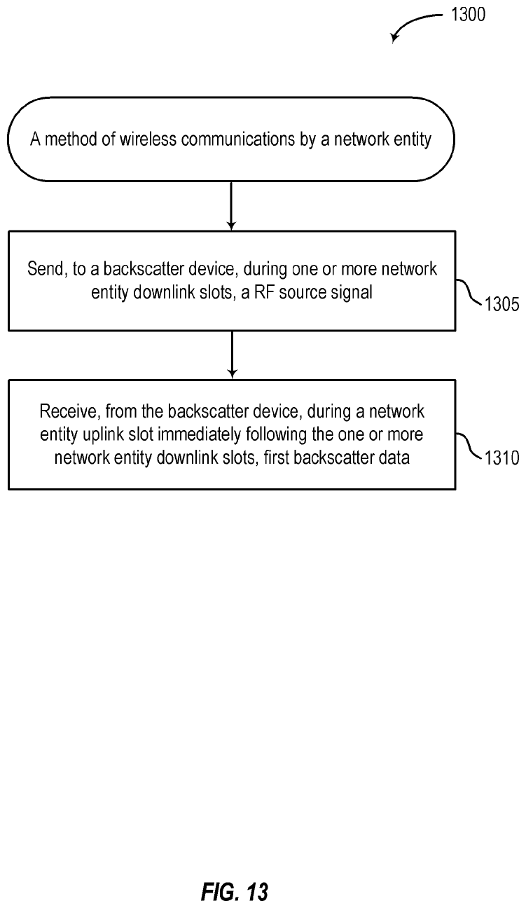

FIG. 13 shows an example of a method 1300 for wireless communications by a network entity, such as BS 102 of FIGS. 1 and 3, or a disaggregated base station as discussed with respect to FIG. 2.

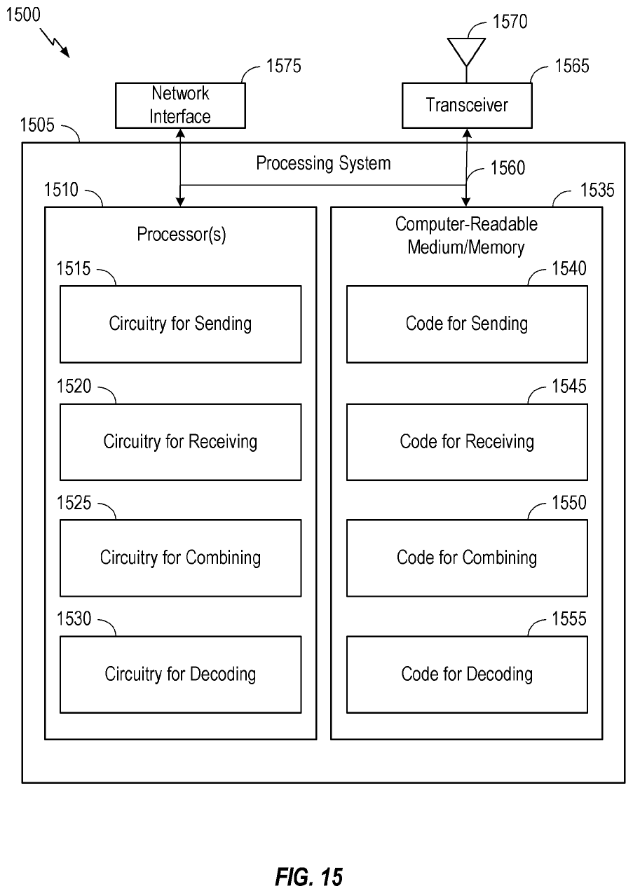

Method 1300 begins at step 1305 with sending, to a backscatter device, during one or more network entity downlink slots, a RF source signal. In some cases, the operations of this step refer to, or may be performed by, circuitry for sending and/or code for sending as described with reference to FIG. 15.

Method 1300 then proceeds to step 1310 with receiving, from the backscatter device, during a network entity uplink slot immediately following the one or more network entity downlink slots, first backscatter data. In some cases, the operations of this step refer to, or may be performed by, circuitry for receiving and/or code for receiving as described with reference to FIG. 15.

In some aspects, the method 1300 further includes receiving, from a user equipment, second backscatter data. In some cases, the operations of this step refer to, or may be performed by, circuitry for receiving and/or code for receiving as described with reference to FIG. 15.

In some aspects, the method 1300 further includes combining, at the network entity, the first backscatter data and the second backscatter data to generate a backscatter data package. In some cases, the operations of this step refer to, or may be performed by, circuitry for combining and/or code for combining as described with reference to FIG. 15.

In some aspects, the method 1300 further includes decoding the backscatter data package. In some cases, the operations of this step refer to, or may be performed by, circuitry for decoding and/or code for decoding as described with reference to FIG. 15.

In some aspects, the method 1300 further includes sending, to the user equipment, an indication to relay the second backscatter data to the network entity. In some cases, the operations of this step refer to, or may be performed by, circuitry for sending and/or code for sending as described with reference to FIG. 15.

In some aspects, the method 1300 further includes sending, to a user equipment, the first backscatter data. In some cases, the operations of this step refer to, or may be performed by, circuitry for sending and/or code for sending as described with reference to FIG. 15.

In some aspects, the method 1300 further includes sending, to the user equipment, an indication that the first backscatter data will be relayed to the user equipment. In some cases, the operations of this step refer to, or may be performed by, circuitry for sending and/or code for sending as described with reference to FIG. 15.

In some aspects, the backscatter device comprises a RFID tag.

In some aspects, the backscatter device comprises a second user equipment comprising a RFID tag radio.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3, or a backscatter user equipment, such as described with respect to FIG. 5.

The communications device 1400 includes a processing system 1405 coupled to the transceiver 1475 (e.g., a transmitter and/or a receiver). The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform: the method 1000 described with respect to FIG. 10, or any aspect related to it; the method 1100 described with respect to FIG. 11, or any aspect related to it; and/or the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for receiving 1445, code for combining 1450, code for decoding 1455, code for sending 1460, and code for transmitting 1465. Processing of the code for receiving 1445, code for combining 1450, code for decoding 1455, code for sending 1460, and code for transmitting 1465 may cause the communications device 1400 to perform: the method 1000 described with respect to FIG. 10, or any aspect related to it; the method 1100 described with respect to FIG. 11, or any aspect related to it; and/or the method 1200 described with respect to FIG. 12, or any aspect related to it.

The one or more processors 1410 include circuitry configured to implement (e.g., execute) the code stored in the computer-readable medium/memory 1440, including circuitry such as circuitry for receiving 1415, circuitry for combining 1420, circuitry for decoding 1425, circuitry for sending 1430, and circuitry for transmitting 1435. Processing with circuitry for receiving 1415, circuitry for combining 1420, circuitry for decoding 1425, circuitry for sending 1430, and circuitry for transmitting 1435 may cause the communications device 1400 to perform: the method 1000 described with respect to FIG. 10, or any aspect related to it; the method 1100 described with respect to FIG. 11, or any aspect related to it; and/or the method 1200 described with respect to FIG. 12, or any aspect related to it.

Various components of the communications device 1400 may provide means for performing: the method 1000 described with respect to FIG. 10, or any aspect related to it; the method 1100 described with respect to FIG. 11, or any aspect related to it; and/or the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1475 and the antenna 1480 of the communications device 1400 in FIG. 14. Means for receiving or obtaining may include transceivers 354 and/or antenna(s) 352 of the UE 104 illustrated in FIG. 3 and/or the transceiver 1475 and the antenna 1480 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1565 (e.g., a transmitter and/or a receiver) and/or a network interface 1575. The transceiver 1565 is configured to transmit and receive signals for the communications device 1500 via the antenna 1570, such as the various signals as described herein. The network interface 1575 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1535 stores code (e.g., executable instructions), such as code for sending 1540, code for receiving 1545, code for combining 1550, and code for decoding 1555. Processing of the code for sending 1540, code for receiving 1545, code for combining 1550, and code for decoding 1555 may cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry such as circuitry for sending 1515, circuitry for receiving 1520, circuitry for combining 1525, and circuitry for decoding 1530. Processing with circuitry for sending 1515, circuitry for receiving 1520, circuitry for combining 1525, and circuitry for decoding 1530 may cause the communications device 1500 to perform the method 1300 as described with respect to FIG. 13, or any aspect related to it.

Various components of the communications device 1500 may provide means for performing the method 1300 as described with respect to FIG. 13, or any aspect related to it. Means for transmitting, sending or outputting for transmission may include transceivers 332 and/or antenna(s) 334 of the BS 102 illustrated in FIG. 3 and/or the transceiver 1565 and the antenna 1570 of the communications device 1500 in FIG. 15. Means for receiving or obtaining may include transceivers 332 and/or antenna(s) 334 of the BS 102 illustrated in FIG. 3 and/or the transceiver 1565 and the antenna 1570 of the communications device 1500 in FIG. 15.

### EXAMPLE CLAUSES

Implementation examples are described in the following numbered clauses:

Clause 1: A method of wireless communications by a user equipment, comprising: receiving, from a backscatter device, first backscatter data during one or more network entity downlink slots; receiving, from the backscatter device, during a network entity uplink slot immediately following the one or more network entity downlink slots, second backscatter data; and combining, at the user equipment, the first backscatter data and the second backscatter data to generate a backscatter data package.

Clause 2: The method of Clause 1, further comprising: decoding the backscatter data package.

Clause 3: The method of any one of Clauses 1 and 2, further comprising: sending, to a reading device, the backscatter data package.

Clause 4: The method of Clause 3, wherein the backscatter data package comprises I/Q data.

Clause 5: The method of Clause 3, wherein the backscatter data package comprises log likelihood ratio data.

Clause 6: The method of Clause 3, wherein sending, to the reading device, the backscatter data package comprises one of: amplifying and forwarding the backscatter data package; delaying and forwarding the backscatter data package; or compressing and forwarding the backscatter data package.

Clause 7: The method of Clause 3, wherein the reading device is a network entity.

Clause 8: The method of Clause 3, wherein the reading device is another user equipment.

Clause 9: The method of any one of Clauses 1-8, further comprising: transmitting, to the backscatter device, a RF source signal during the network entity uplink slot.

Clause 10: The method of Clause 9, wherein the user equipment is configured in a full-duplex in-band operating mode in order to transmit the RF source signal and receive the second backscatter data during the network entity uplink slot.

Clause 11: The method of Clause 9, further comprising: receiving, from a network entity, a configured uplink grant, wherein transmitting the RF source signal during the network entity uplink slot is performed in accordance with the configured uplink grant.

Clause 12: The method of Clause 11, further comprising: receiving, from the network entity, a semi-persistent scheduling configuration; and receiving, from the network entity, the configured uplink grant during a PDCCH occasion scheduled based on the semi-persistent scheduling configuration.

Clause 13: The method of any one of Clauses 1-12, wherein the backscatter device comprises a RFID tag.

Clause 14: The method of any one of Clauses 1-13, wherein the backscatter device comprises a second user equipment comprising a RFID tag radio.

Clause 15: A method of wireless communications by a backscatter user equipment, comprising: receiving, from a network entity, a first RF source signal during one or more network entity downlink slots; sending, to a first user equipment, first backscatter data during at least a portion of the one or more network entity downlink slots; and sending, to the first user equipment, during a network uplink slot immediately following the one or more network entity downlink slots, second backscatter data.

Clause 16: The method of Clause 15, further comprising: receiving a second RF source signal during the network uplink slot.

Clause 17: The method of Clause 16, wherein the second RF source signal is received from the first user equipment.

Clause 18: The method of Clause 16, wherein the second RF source signal is received from a second user equipment.

Clause 19: The method of any one of Clauses 15-18, wherein sending, to the first user equipment, during the network uplink slot, the second backscatter data comprises sending the second backscatter data using energy from an energy storage device within the backscatter user equipment.

Clause 20: The method of Clause 19, wherein sending, to the first user equipment, during the network uplink slot, the second backscatter data comprises sending the second backscatter data using energy from an energy storage device within the backscatter user equipment and energy harvested from the second RF source signal.

Clause 21: The method of any one of Clauses 15-20, wherein the backscatter user equipment comprises a RFID tag.

Clause 22: The method of any one of Clauses 15-21, wherein the backscatter user equipment comprises a RFID tag radio.

Clause 23: A method of wireless communications by a user equipment, comprising: receiving, from a backscatter device, first backscatter data during one or more network entity downlink slots; and sending, to the backscatter device, during a network entity uplink slot immediately following the one or more network entity downlink slots, a RF source signal.

Clause 24: The method of Clause 23, further comprising: receiving, from a network entity, second backscatter data; combining, at the user equipment, the first backscatter data and the second backscatter data to generate a backscatter data package; and decoding the backscatter data package.

Clause 25: The method of Clause 24, further comprising: receiving, from the network entity, an indication that the second backscatter data will be relayed to the user equipment.

Clause 26: The method of any one of Clauses 23-25, further comprising: sending, to a network entity, the first backscatter data.

Clause 27: The method of Clause 26, further comprising: receiving, from the network entity, and indication to relay the first backscatter data to the network entity.

Clause 28: The method of any one of Clauses 23-27, wherein the backscatter device comprises a RFID tag.

Clause 29: The method of any one of Clauses 23-28, wherein the backscatter device comprises a second user equipment comprising a RFID tag radio.

Clause 30: A method of wireless communications by a network entity, comprising: sending, to a backscatter device, during one or more network entity downlink slots, a RF source signal; and receiving, from the backscatter device, during a network entity uplink slot immediately following the one or more network entity downlink slots, first backscatter data.

Clause 31: The method of Clause 30, further comprising: receiving, from a user equipment, second backscatter data; combining, at the network entity, the first backscatter data and the second backscatter data to generate a backscatter data package; and decoding the backscatter data package.

Clause 32: The method of Clause 31, further comprising: sending, to the user equipment, an indication to relay the second backscatter data to the network entity.

Clause 33: The method of any one of Clauses 30-32, further comprising: sending, to a user equipment, the first backscatter data.

Clause 34: The method of Clause 33, further comprising: sending, to the user equipment, an indication that the first backscatter data will be relayed to the user equipment.

Clause 35: The method of any one of Clauses 30-34, wherein the backscatter device comprises a RFID tag.

Clause 36: The method of any one of Clauses 30-35, wherein the backscatter device comprises a second user equipment comprising a RFID tag radio.

Clause 37: An apparatus, comprising: a memory comprising executable instructions; and a processor configured to execute the executable instructions and cause the apparatus to perform a method in accordance with any one of Clauses 1-36.

Clause 38: An apparatus, comprising means for performing a method in accordance with any one of Clauses 1-36.

Clause 39: A non-transitory computer-readable medium comprising executable instructions that, when executed by a processor of an apparatus, cause the apparatus to perform a method in accordance with any one of Clauses 1-36.

Clause 40: A computer program product embodied on a computer-readable storage medium comprising code for performing a method in accordance with any one of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g, a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications by a user equipment, comprising:
receiving, from a backscatter device, first backscatter data during one or more network entity downlink slots;
receiving, from the backscatter device, during a network entity uplink slot immediately following the one or more network entity downlink slots, second backscatter data; and
combining, at the user equipment, the first backscatter data and the second backscatter data to generate a backscatter data package.

2. The method of claim 1, further comprising decoding the backscatter data package.

3. The method of claim 1, further comprising sending, to a reading device, the backscatter data package.

4. The method of claim 3, wherein the backscatter data package comprises I/Q data.

5. The method of claim 3, wherein the backscatter data package comprises log likelihood ratio data.

6. The method of claim 3, wherein sending, to the reading device, the backscatter data package comprises one of:
amplifying and forwarding the backscatter data package;
delaying and forwarding the backscatter data package; or
compressing and forwarding the backscatter data package.

7. The method of claim 3, wherein the reading device is a network entity.

8. ethod of claim 3, wherein the reading device is another user equipment.

9. ethod of claim 1, further comprising transmitting, to the backscatter device, a radio frequency (RF) source signal during the network entity uplink slot.

10. The method of claim 9, wherein the user equipment is configured in a full-duplex in-band operating mode in order to transmit the RF source signal and receive the second backscatter data during the network entity uplink slot.

11. The method of claim 9, further comprising:
receiving, from a network entity, a configured uplink grant,
wherein transmitting the RF source signal during the network entity uplink slot is performed in accordance with the configured uplink grant.

12. The method of claim 11, further comprising:
receiving, from the network entity, a semi-persistent scheduling configuration; and
receiving, from the network entity, the configured uplink grant during a physical downlink control channel (PDCCH) occasion scheduled based on the semi-persistent scheduling configuration.

13. The method of claim 1, wherein the backscatter device comprises a radio frequency identification (RFID) tag.

14. The method of claim 1, wherein the backscatter device comprises a second user equipment comprising a radio frequency identification (RFID) tag radio.

15. A user equipment configured for wireless communication, comprising: a memory comprising computer-executable instructions; and one or more processors configured to execute the computer-executable instructions and cause the user equipment to:
receive, from a backscatter device, first backscatter data during one or more network entity downlink slots;
receive, from the backscatter device, during a network entity uplink slot immediately following the one or more network entity downlink slots, second backscatter data; and
combine, at the user equipment, the first backscatter data and the second backscatter data to generate a backscatter data package.

16. A method of wireless communications by a backscatter user equipment, comprising:
receiving, from a network entity, a first radio frequency (RF) source signal during one or more network entity downlink slots;
sending, to a first user equipment, first backscatter data during at least a portion of the one or more network entity downlink slots; and
sending, to the first user equipment, during a network uplink slot immediately following the one or more network entity downlink slots, second backscatter data.

17. The method of claim 16, further comprising receiving a second RF source signal during the network uplink slot.

18. The method of claim 17, wherein the second RF source signal is received from the first user equipment.

19. The method of claim 17, wherein the second RF source signal is received from a second user equipment.

20. The method of claim 16, wherein sending, to the first user equipment, during the network uplink slot, the second backscatter data comprises sending the second backscatter data using energy from an energy storage device within the backscatter user equipment.

21. The method of claim 19, wherein sending, to the first user equipment, during the network uplink slot, the second backscatter data comprises sending the second backscatter data using energy from an energy storage device within the backscatter user equipment and energy harvested from the second RF source signal.

22. The method of claim 16, wherein the backscatter user equipment comprises a radio frequency identification (RFID) tag.

23. The method of claim 16, wherein the backscatter user equipment comprises a radio frequency identification (RFID) tag radio.

24. A backscatter user equipment configured for wireless communication, comprising: a memory comprising computer-executable instructions; and one or more processors configured to execute the computer-executable instructions and cause the backscatter user equipment to:
receive, from a network entity, a first radio frequency (RF) source signal during one or more network entity downlink slots;
send, to a first user equipment, first backscatter data during at least a portion of the one or more network entity downlink slots; and
send, to the first user equipment, during a network uplink slot immediately following the one or more network entity downlink slots, second backscatter data.
